(19) United States
(12) Patent Application Publication
(10) Pub. No.: US 2011/0266373 A1
(43) Pub. Date: Nov. 3, 2011

(54) NOZZLE ARRANGEMENT

(75) Inventors: Hans Joachim Struck, Offenburg (DE); Lutz Fabiny, Ortenberg (DE)

(73) Assignee: PAPIERMASCHINEN-SYSTEMTECHNIK GMBH, Offenburg (DE)

(21) Appl. No.: 13/098,547

(22) Filed: May 2, 2011

(30) Foreign Application Priority Data
Apr. 30, 2010 (DE) 102010019184.1

(51) Int. Cl. B05B 1/14

(52) U.S. Cl. 239/553

(57) ABSTRACT

A nozzle arrangement (1) for detachable arrangement in an outlet of a tubular nozzle fitting, which is allocated to a high-pressure cleaning or conditioning device of a paper machine, having a rotationally-symmetric nozzle body (2), including a carrier (3) formed as a circular disk with a central recess (5) encompassed thereby and a dome (6) bulging with its wall over the recess (5) at a flat side (4) of the carrier (3), and with a first jet channel (7) penetrating the wall, in which at least one first nozzle element (8) is arranged, which forms the liquid passing the jet channel (7) into a laminar jet. The carrier (3) of the nozzle body (2) has an exterior contour with a constant curvature or one changing in reference to the rotational symmetry axis of the nozzle body (2). In order to provide a nozzle arrangement (1), which is easily produced and improves the cleaning and/or conditioning performance of the allocated nozzle fitting and/or spray tube, and here consumes as little amount of water for cleaning and provides higher flexibility during the cleaning process, the nozzle body (2), in its first jet channel (7) includes at least a second nozzle element (8) or the nozzle body (2) has at least another jet channel (7) penetrating the wall of the dome (6) with at least a second nozzle element (8), each forming a laminar jet, which together with the first jet passes the recess (5) of the carrier (3) and at least the carrier (3) of the nozzle body (2) has a multiple rotational symmetry and the dome (6) has a rotational symmetry of the same or different number as the carrier (3) or is embodied rotationally symmetrical in reference to the rotational axis of the nozzle body (2).

### CROSS-REFERENCE TO RELATED APPLICATIONS

This application claims the benefit of German Patent Application No. 10 2010 019 184.1, filed Apr. 30, 2010, which is incorporated herein by reference as if fully set forth.

### BACKGROUND

The invention relates to a nozzle arrangement for a detachable mounting in the outlet of a tubular nozzle fitting, allocated to a high-pressure cleaning or conditioning device of a paper machine, comprising a rotationally symmetrical nozzle body with a carrier, shaped as a circular disk, having a central recess encompassed thereby and a dome with its walls bulging on a flat side over the carrier and with a first jet channel penetrating the wall, in which at least a first nozzle element is arranged, forming the liquid passing the jet channel into a laminar jet, with the carrier of the nozzle body having an exterior contour with a constant curvature or one changing in reference to the axis of rotational symmetry of the nozzle body.

In paper machines, high-pressure cleaning or condition devices are operated in the form of high-pressure spray tubes, installed for example perpendicular in reference to the so-called X-axis forming the operating direction of the paper machine, and oscillating perpendicularly in reference to said axis, with their objective being the continuous cleaning and/or conditioning of sheet forming sieves, press felts, drying belts, and roller surfaces. Other forms of cleaning devices may be embodied as so-called traversing cleaners, which can be moved along the couch squirt of the paper machine, for example, and are used for cleaning grills or other equipment in different production sections of the paper machine. Here, water is used at an operating pressure ranging from 10 to 50 bar, which is called high-pressure. The Y-axis extends perpendicularly in reference to the X-axis of the machine, and also perpendicular to the Z-axis, which therefore is generally essentially parallel to the longitudinal axis of the nozzle fittings of the spray tube.

These high-pressure (HP)-spray tubes are equipped with high-pressure nozzle arrangements described at the outset, which due to their flat profile can also be called high-pressure nozzle platelets, i.e. with so-called needle jet—nozzles or HP-nozzles.

These HP-nozzle arrangements are formed as platelets and are made from metal by way of punching or machining. They show a round outlet channel, called jet channel, in the primary axis (longitudinal axis) of the nozzle body and emit through it a liquid jet, particularly a water jet, which is also called full jet or needle jet. These HP-nozzles emit a water jet, which is also called full jet or needle jet and essentially shows an annular cross-section.

To this extent, the nozzle arrangements mentioned at the outset are known, for example from DE 20 2005 020 149, with their primary feature being the creation of a water jet having a jet—laminarity as good as possible. It is characterized in the jet not disintegrating into individual drops before impingement. This is primarily achieved by the production of the channel being performed with great precision.

The amount of the volume flow rate of liquids used for the cleaning is determined by the water pressure used and the cross-section of the outlet opening of the water jets, with common diameters showing dimensions of one millimeter.

For economic and ecological reasons, the reduction of water consumption is an important objective of the paper industry. One of the most important measures in this regard is the reduction of the diameter of the jets, and thus the reduction of the volume flow rate. Additionally, it may occur in nozzle arrangements of prior art that, for example, two-layer sheet forming sieves are not sufficiently cleaned or that considerable expense must be invested, here.

### SUMMARY

The objective of the present invention is therefore to provide a nozzle arrangement, that can easily be produced and which improves the cleaning and/or conditioning performance of the allocated nozzle fitting and/or spray tube, and here consumes a lesser amount of water and provides higher flexibility during the cleaning process.

This objective is attained in a nozzle arrangement of the type mentioned at the outset, in which at the nozzle body, in its first jet channel, at least a second nozzle element is provided or at least another jet channel penetrating the wall of the dome at the nozzle body, each to form a laminar jet, which together with the first jet passes through the recess of the carrier and that at least the carrier of the nozzle body comprises a multiple rotational symmetry and the dome has a rotational symmetry of the same or a different number as the carrier, or is embodied rotationally symmetrical with regards to the rotational axis of the nozzle body.

Due to the fact that now several nozzle elements are provided at the nozzle body a better cleaning and conditioning performance of the nozzle device can be achieved with simultaneously reduced water consumption because less liquid is consumed in an arrangement of several jets with reduced jet diameter, compared to a single jet of prior art with its diameter being comparable to the sum of the jets with reduced diameters. By the reduction of the diameter and a doubling of the number of jets adequate cleaning and conditioning performance of the nozzle is achieved with significantly reduced water consumption. For example, under the same water pressure the volume flow rates of two jets with a diameter of 0.5 mm show only approximately 60% of the volume flow rate of a jet with a diameter of 1.0 mm.

Simultaneously, via the exterior contour of the carrier of the nozzle body having a changing curvature the position of the inserted nozzle platelet can be defined in reference to its insertion into the respective nozzle fitting of the cleaning device of the paper machine and can here be rotated into one or more positions, namely also by an operator not specifically qualified for this task. Here, the nozzle body may be arranged in a radial section of the spray tube, at which the nozzle fitting is arranged. The alignment of the high-pressure nozzle platelet may be performed during the installation such that the nozzle elements are side-by-side in the X-direction, as well as off-set for example at an angle of 45° in reference to the X-direction or also side-by-side along the Y-direction, i.e. off-set by 90°. Simultaneously a Z-component of the axes of the water jets can develop caused by the radial off-set of the nozzle fitting at the spray tube. By arranging the jets perpendicularly in reference to the X-axis of the machine the total number of jets emitted by the spray tube is doubled, for example, resulting in an increased cleaning and/or conditioning performance of the spray tube.

Due to the fact that at least the carrier of the nozzle body shows a multiple rotational symmetry and the dome has a rotational symmetry of the same or a different number as the carrier or is embodied rotationally symmetrically with regards to the rotational axis of the nozzle body, particularly the positioning of the nozzles at a certain angle can at least be in generally assessed already by the position of the carrier in reference to the X-axis of the paper machine or with regards to the spray tube.

The jets may exit parallel in reference to each other or at an angle in reference to the Z-axis. Here, by the angular position between the jet axes, for example, an increase in the cleaning and/or conditioning performance of the spray tube and a more thorough cleaning of two-layer sheet forming sieves can occur. When the jets are arranged parallel in reference to the X-axis, an increase of the cleaning and/or conditioning performance of each individual nozzle can be achieved, which results in further intensifying the cleaning of sieves and the conditioning of felts when the jets exit at an angle in reference to the Z-axis.

In an advantageous embodiment of the nozzle arrangement the recess of the carrier is embodied rotationally symmetrically with regards to the rotational symmetry axis of the nozzle body so that a jet channel is formed simply by a potential rotation of the nozzle body at its receiver in a synchronous fashion, not influencing the configuration of the nozzle elements. Here, rotational symmetry shall be understood as the variance under an arbitrary rotation around the respective rotational axis.

In an advantageous embodiment of the nozzle arrangement, in which water can flow easily to the nozzle body in its nozzle fitting, for example, the dome is embodied in the form of a spherical cap, an ellipsoid, a partial sphere, a cylinder section, or a frustum.

In an advantageous further development, the nozzle arrangement, at which the nozzle elements can be easier arranged during the production than in a completely curved dome, comprises a dome showing a flattened bottom at its side facing away from the carrier.

The bottom, here arranged as a parallel level in reference to the recess of the carrier, may be provided for example particularly easily with penetrations as nozzle elements, arranged perpendicularly in reference to the bottom and/or the parallel level, so that beneficially but not necessarily another further development of the nozzle arrangement may comprise that at least one nozzle element, preferably all nozzle elements, are arranged penetrating the bottom of the dome.

In another embodiment of the nozzle arrangement, advantageous because it influences the liquid jet as little as possible except in its shape as a laminar jet, the nozzle body comprises a flat profile with a short length, compared to the lateral extension in the level of the carrier, parallel to the extension of the jet channel.

A particularly preferred embodiment of the nozzle arrangement according to the invention, in which the optimization of a good cleaning and condition performance on the one hand and a reduced water consumption on the other hand is well achieved, the nozzle body is provided with one or two nozzle elements and the nozzle elements are located on a straight line intersecting a plane projection of the bottom of the dome so that a clear positioning is possible with regards to the axis, primarily defined by the paper machine, at all times and without major expenses.

In an embodiment of the nozzle arrangement allowing a relatively simple change of the configuration of the nozzle body in its nozzle fitting by the engagement of a tool at the nozzle body the exterior contour of the body basis is formed by two convexly curved contour sections, connected by two straight contour sections, and then showing an approximately oval-rectangular shape.

An advantageous embodiment, different with regards to its exterior contour from the above-mentioned ones, for the defined positioning of the nozzle arrangement is characterized in that it comprises at its carrier a closed polygonal pull, preferably showing equally long straight contour sections and rounded corners, particularly an octagon, allowing that the nozzle body can be rotated at least in reference to its previous position, for example by a tool such as a wrench, in order to change the configuration of the nozzle elements. For the contour section, in the accepting opening of the nozzle fitting a complementary approximately matching area may be provided which the contour section contacts in the operating position, at least partially, which in turn prevents any unintended rotation of the nozzle body during operation.

A further development of the nozzle arrangement is adjustable to different situations and requirements, with the nozzle elements creating laminar jets of identical or different diameters and perhaps having one or more jets with different diameters, for example larger or smaller diameters of exterior jets in reference to a central jet, such as in a three-jet nozzle arrangement.

Advantageous embodiments of the nozzle arrangement may here have a lateral extension of the water jets ranging from approximately 0.1 mm to 1.2 mm, preferably from 0.2 mm to 0.9 mm, particularly preferred from 0.3 mm to 0.6 mm.

Nozzle arrangements, in which also the jet direction is held in a variable fashion, can be used even more flexibly with here, in another embodiment, beneficially the longitudinal axes of the nozzle elements provided in the nozzle body are aligned parallel to the rotational axis of the nozzle body or form an acute angle with the axis so that the area that can be covered by the water jets of a nozzle arrangement can also be expanded, here. When setting the angle it must be observed preferably that the jets of the same of neighboring nozzle devices are not contacting each other, which may lead to jets no longer being defined and potentially damaging of the machine. In order to avoid such an occurrence, for example a number of nozzle fittings of the nozzle arrangements positioned side-by-side may be aligned with diverging jets showing an off-set angle in reference to the alignment of the arrangement.

A further development of the nozzle arrangement of a nozzle body comprising an angularly arrangement nozzle element, may show that the bottom of the dome of the nozzle body is bulging towards the central recess of the carrier in which the nozzle elements are essentially arranged in a radial orientation, with the respective nozzle element penetrating the allocated section of the bottom of the dome such that the longitudinal axis of the nozzle element coincides with the normal level of the bulged area of the wall of the dome at the outlet opening of the nozzle element and thus the angle is predetermined by the respective bulge with regards to the rotational axis. However, another way to create diverging laminar jets is also possible, for example an intentionally diagonal insertion of one or more nozzle elements into a planar bottom of the dome.

An embodiment of the nozzle arrangement, easily assembled at the nozzle fitting and disassembled, may provide the carrier of the nozzle body such that it comprises a section encompassing the recess and projecting into it essentially parallel in reference to the lateral extension of the nozzle body, forming an undercut together with the interior wall of the dome of the nozzle body. The respective projection encircling the recess forms a type of groove at its side facing the bulge of the dome, which for example can be engaged by the claw of a tool and can separate the nozzle body from the nozzle fitting.

An embodiment of the nozzle arrangement can easily be produced in which the carrier and the dome together form a one-piece nozzle body, particularly produced by way of cutting material processing as a punched or machined part or the like.

The jet channels of the nozzle arrangement according to the invention may be embodied, on the one hand, for example as a bore penetrating the wall of the dome, perhaps with a cross-section changing over its length, with then the nozzle elements forming the section of the bore at the inlet side. On the other hand, in an advantageous further development of the nozzle arrangement the jet channels may also be provided with nozzle elements, embodied as an insert that can be fixed in the receiver of the jet channel, with this then particularly preferred insert that can be pressed into the receiver being made from a hard material, such as ruby, sapphire, diamond, ceramics, or a hard metal, particularly a mono-crystalline material. Here, the insert and the receiver may have the same nominal measure as exterior and/or interior diameters, so that the insert of the nozzle element is held in its position by the press fit formed in this manner.

When the nozzle fittings provided to receive the nozzle arrangements comprise for example a flange for fastening, a beneficial further development of the nozzle arrangement according to the invention may comprise to equip the nozzle body at the bulging side with a planar encircling area at the carrier, which then in the operating position contacts the respective flange area of the allocated nozzle fitting.

In order to protect the nozzle arrangement from leakage and thus the seeping of liquids, between the flange area of the nozzle fitting and the opposite nozzle body area beneficially a sealant can be provided, particularly an annular sealing ring, which encircles the nozzle body prevents any liquid from penetrating between the flange area and the carrier of the base of the body. Here, the sealant can be embodied preferably as a so-called flat seal with an essentially rectangular cross-section.

Instead of a flat seal, other rounded or circular cross-sections may also be given for the seal, so that in another embodiment at the planar section of the nozzle body allocated to the carrier a circumferential, groove-shaped receiver is provided which at least partially accepts the cross-section of the seal.

Using a fixing means, another embodiment of the nozzle arrangement can easily be fixed at the respectively allocated nozzle fitting, released therefrom, and then also arranged adjustable in its rotational configuration, so that in a further development the nozzle arrangement can be fastened via a fixing element, particularly a cap nut with an interior thread, to the nozzle fitting and fixed in a torque-proof fashion in its operational position.

In order to clear the nozzle arrangement from time to time with a reasonable expense from any contaminants caused by the spray tube or entrained in the liquid, in another embodiment of the nozzle arrangement the nozzle body may project into the nozzle holder in the operating position upstream in the direction of the cross-section of the spray tube to such an extent that the inlet openings of the nozzle elements can be contacted by cleaning elements arranged in the spray tube, particularly by the bristles of a rotating brush having a multitude of arms.

### BRIEF DESCRIPTION OF THE DRAWINGS

In the following, the invention is explained in greater detail using the exemplary embodiments of the drawing. Here shown in a partially schematic illustration are

FIG. 1 is a level side view of the inlet side of a first exemplary embodiment of the nozzle arrangement with two nozzle elements showing an essentially octagonal contour of the carrier;

FIG. 2 is a level side view of the downstream side of a second exemplary embodiment of the nozzle arrangement with two nozzle elements having an oval-rectangular contour of the carrier;

FIG. 3 is a partially cross-sectioned side view of another exemplary embodiment of the nozzle arrangement with a flattened dome area with a flat seal and a parallel axial arrangement of the nozzle elements;

FIG. 4 is a partially cross-sectioned side view of another exemplary embodiment of the nozzle arrangement with a bulged dome bottom and without any seal;

FIG. 5 is a partially cross-sectioned side view of another exemplary embodiment of the nozzle arrangement with a thickened material cross-section, with inserted nozzle elements with parallel axes as inserts into the jet channel;

FIG. 6 is a partially cross-sectioned side view of a view similar to FIG. 5 of another exemplary embodiment of the nozzle arrangement with a higher dome as well as a bulged dome bottom, in which nozzle elements with diverging jets are arranged embodied as an insert and with an annular seal accepted in a groove.

### DETAILED DESCRIPTION OF THE PREFERRED EMBODIMENTS

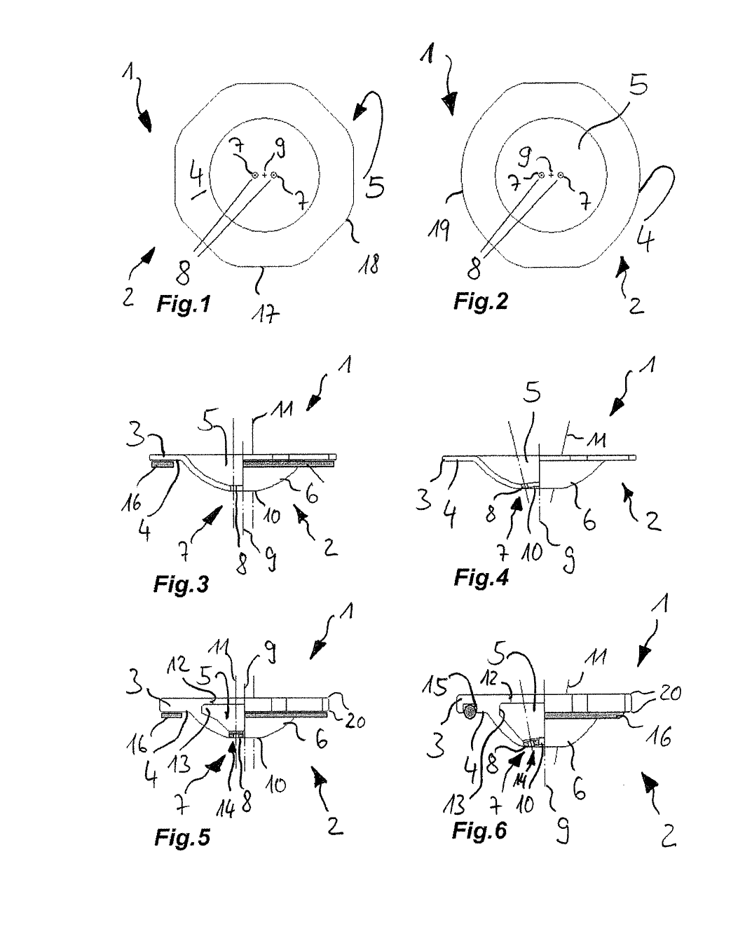

FIGS. 1 through 6 each show a nozzle arrangement, in its entirety marked 1, to be arranged in the outlet of a tubular nozzle fitting, not shown, allocated to a spray tube, not shown either, which spray tube in turn being arranged at a cleaning device of a paper machine, again not shown.

The nozzle arrangement 1 is provided with a rotationally symmetrical nozzle body 2, which comprises a carrier 3 in the form of an annular disk with a central, here circular recess 5. Over a flat side 4 of the carrier 3 a dome 6 bulges with its wall over the recess 5, with two jet channels 7 penetrating the wall of the dome, in which nozzle elements 8 are arranged forming the liquid passing the respective jet channel 7 into a laminar jet.

Additionally, the carrier 3 of the nozzle body 2 in FIGS. 1 through 6 each shows an exterior contour with a curvature changing in reference to the rotational symmetry axis 9 of the nozzle body 2.

Here, the exterior contours of the carriers 3 of the nozzle arrangements 1 of FIGS. 1 and 2 are shaped differently, namely on the one hand in FIG. 1 with a closed polygonal pull with equally long straight contour sections 17 of the carrier 3 and rounded corner sections 18 and in FIG. 2 with two convexly curved contour sections 19 connected by two straight contour sections 17, so that here the carrier 3 is provided with four rounded corners 18, alternating connected by a straight and an oval rounded contour section 17, 19. Further it is discernible in FIGS. 1 and 2 that the recess 5 of the body basis 3 is embodied rotationally symmetrical with regards to the rotational symmetry axis 9 of the nozzle body 2. Further, the carrier 3 of the nozzle body 2 comprises multiple rotational symmetries each, in FIG. 1 an eight count, in FIG. 2 a two count, which is equivalent to a rotation by 45° and 180°, respectively, until equivalence, with this not being required for the nozzle arrangement 1, though, because intentionally various configurations shall be possible by way of rotating. The dome 6 of the nozzle arrangements 1 shows a bivalent symmetry by the arrangement of the nozzle elements 8 and thus the same as the body basis of the nozzle arrangement of FIG. 2, however different from the one of the nozzle arrangement of FIG. 1.

In FIGS. 3 through 6 various embodiments of nozzle arrangements 1 each with an octagon exterior contour of the carrier 3 are shown and it is discernible, that in the nozzle arrangements 1, here the dome 6 comprises at its side facing away from the carrier 3 a flattened bottom 10 compared to the original bulge of the dome 6, and that the nozzle elements 8 are arranged at the nozzle body 2 penetrating the bottom 10 of the dome 6. Additionally, it is discernible from FIGS. 3 through 6 that the nozzle body 2 comprises a flat profile, compared to the lateral extension in the level of the carrier 3 of a short length, parallel to the extension of the jet channel 7. At the nozzle bodies 2 of the nozzle arrangements 1 of FIGS. 3 through 6 two nozzle elements 8 are each provided and the nozzle elements 8 are located on a straight line intersecting a plane projection of the bottom of the dome 10.

In the illustrations of FIGS. 3 and 5 the longitudinal axes 11 of the jet elements 8 and/or jet channels 7, provided in the nozzle body 2, are aligned parallel in reference to the rotational axis 9 of the nozzle body 2, while in the illustrations of FIGS. 4 and 6 the longitudinal axes 11 each form an identical acute angle with the rotational axis 9, which leads to diverging laminar jets. Here, the acute angle between the axes 9, 11 develops by the bottom of the dome 10 of the respective nozzle body 2 comprising a bulge towards the central recess 5 of the carrier 3, in which the jet channels 7 and/or the nozzle elements 8 are aligned such that the longitudinal axis 11 of a nozzle element 8 and/or a jet channel 7 coincides with the normal of the bulged area of the dome wall at the outlet opening of the respective nozzle element 8.

In the nozzle arrangements 1 of FIGS. 5 and 6, simultaneously provided with a reinforced material cross-section of the carrier 3 and the wall of the dome 6, the carrier 3 comprises a section 12, respectively encompassing a recess 5 and essentially extending it parallel to the lateral extension of the nozzle body, which together with the interior wall of the dome forms an undercut in the type of a groove 13 so that the nozzle body 2 can easily be engaged by a tool, not shown. Also discernible from the illustrations of FIGS. 5 and 6 is the fact that the carrier 3 of the nozzle body 2, in the edge area of its exterior contour, comprises a circumferential bevel 20 each adjacent to the two flat sides 4 of the carrier.

While the nozzle elements 8 and/or the jet channels 7 are embodied as penetrations of the bottom of the dome in the form of a bore at the nozzle bodies 2 of the nozzle arrangements 1 of FIGS. 3 and 4, at the bottoms 10 of the nozzle arrangements 1 of FIGS. 5 and 6 the recesses 14 are provided, in which nozzle elements 8, formed from a hard material, such as ruby for example, are received as inserts in the respective jet channel 7.

For a tight fit in a nozzle fitting, not shown, the carrier 3 of the nozzle body 2 is embodied planar such that in the operational position a sealant 16 can be arranged in the area of the carrier 3 adjacent to the respective flange area of the nozzle fitting, as discernible from the illustrations of FIGS. 3, 5. While in FIGS. 3 and 5 the respective seal 16 is embodied with a flat, rectangular cross-section, in FIG. 6 it is provided as an annular seal 16 with an additionally circular, round cross-section, which is received in the carrier 3 in a circumferential, groove-like recess 15 with a part of its cross-section.

The above-described invention therefore relates to a nozzle arrangement 1 for the detachable arrangement in the outlet of a tubular nozzle fitting, which is allocated to a high-pressure cleaning or conditioning device of a paper machine, having a rotationally-symmetric nozzle body 2, comprising a carrier 3 formed as a circular disk with a central recess 5, encompassed thereby, and a dome 6 bulging with its wall over the recess 5 on a flat side 4 of the carrier, and a first jet channel 7 penetrating the wall, in which at least a first nozzle element 8 is arranged, which forms the liquid passing the jet channel 7 into a laminar jet, with the carrier 3 of the nozzle body 2 comprising an exterior contour with a constant curvature or one changing in reference to the rotational symmetry 9 of the nozzle body 2.

In order to provide a nozzle arrangement 1, which can easily be produced and improves the cleaning and/or conditioning performance of the allocated nozzle holder and/or spray tube, and simultaneously consuming a lesser amount of water as the cleaning liquid and providing higher flexibility during the cleaning process it is suggested to provide at least a second nozzle element 8 at the nozzle body 2 in its first jet channel 7 or at least another jet channel 7 penetrating the wall of the dome 6 at the nozzle body 2 with at least one additional nozzle element 8, each to form a laminar jet, which together with the first jet passes the recess 5 of the carrier 3 and at least the carrier 3 of the nozzle body 2 comprising a multiple rotational symmetry and the dome 6 comprising a rotational symmetry of equal or different number than the carrier 3 or being rotationally symmetrical with regards to the rotational axis of the nozzle body 2.

1. A nozzle arrangement for detachable arrangement in an outlet of a tubular nozzle fitting, for a high-pressure cleaning or conditioning device of a paper machine, the nozzle arrangement comprising a rotationally-symmetric nozzle body, with a carrier formed as a circular disk with a central recess encompassed thereby and a dome with a wall bulging over the central recess at a flat side of the carrier, and having a first jet channel penetrating the wall, in which at least one first nozzle element is arranged, which is adapted to form liquid passing therethrough into a laminar jet, with the carrier of the nozzle body having an exterior contour with a constant curvature or one changing in reference to a rotational symmetry axis of the nozzle body, at least one additional nozzle element (8) is arranged at the nozzle body (2) in a first jet channel (7) or at least another jet channel (7) penetrating the wall of the dome at the nozzle body (2) having the at least one additional nozzle element (8) such that each are adapted to form a laminar jet, which together with the first jet passes the recess (5) of the carrier (3) and at least the carrier (3) of the nozzle body (2) comprises a multiple rotational symmetry and the dome (6) has a rotational symmetry of the same or different number as the carrier (3) or is embodied rotationally symmetrical with regards to the rotational axis of the nozzle body (2).

2. The nozzle arrangement according to claim 1, wherein the recess (5) of the carrier (3) is embodied rotationally symmetrical in reference to a rotational symmetry axis (9) of the nozzle body (2).

3. The nozzle arrangement according to claim 2, wherein the dome is embodied as a spherical cap, an ellipsoid, a partial sphere, a cylinder part, or a frustum.

4. The nozzle arrangement according to claim 1, wherein the dome (6) comprises a flattened bottom (10) at a side thereof facing away from the carrier (3).

5. The nozzle arrangement according to claim 1, wherein the at least one additional nozzle element (8) is arranged at the nozzle body (2) penetrating the bottom (10) of the dome (6).

6. The nozzle arrangement according to claim 1, wherein the nozzle body (2) comprises a flat profile with a short length in reference to a lateral extension in a plane of the carrier (3), parallel to an extension of the jet channel (7).

7. The nozzle arrangement according to claim 1, wherein the at least one additional nozzle element (8) is provided at the nozzle body (2) and the nozzle elements are located on a straight line intersecting a planar projection of a bottom (10) of the dome (6).

8. The nozzle arrangement according to claim 1, wherein an exterior contour of the carrier (3) is formed by two curved contour sections (19) connected by two straight contour sections (17).

9. The nozzle arrangement according to claim 1, wherein an exterior contour of the carrier (3) comprises a closed polygonal pull with equally long straight contour sections (17) and rounded corner sections (18).

10. The nozzle arrangement according to claim 1, wherein a diameter of the water jets each ranges from approximately 0.1 mm to 1.2 mm.

11. The nozzle arrangement according to claim 1, wherein a longitudinal axis (11) of the nozzle elements (8) provided in the nozzle body (2) is aligned parallel in reference to a rotational axis (9) of the nozzle body (2) or respectively form an acute angle with the rotational axis (9).

12. The nozzle arrangement according to claim 11, wherein the bottom (10) of the dome (6) of the nozzle body (2) comprises a bulge facing the central recess (5) of the carrier (3).

13. The nozzle arrangement according to claim 12, wherein the longitudinal axis of the nozzle element (8) coincides with a normal of a curved area of the wall of the dome (6) at the outlet opening of the nozzle element (8).

14. The nozzle arrangement according to claim 1, wherein the carrier (3) comprises a section (12) encompassing the recess (5), essentially extending parallel to a lateral extension of the nozzle body (2), forming an undercut with an interior wall of the dome (6).

15. The nozzle arrangement according to claim 1, wherein the carrier (3) together with the dome (6) is provided as a one-piece nozzle body (2).

16. The nozzle arrangement according to claim 1, wherein the jet channel or channels (7) with the respectively allocated nozzle elements (8) are embodied as bores penetrating the wall of the dome (6) with a cross-section that changes over a length thereof.

17. The nozzle arrangement according to claim 1, wherein the jet channel or channels (7) are provided with the nozzle elements, embodied as an insert that can be fastened in a recess (14) of a respectively allocated one of the jet channels (7).

18. The nozzle arrangement according to claim 17, wherein the insert, which can be impressed, comprises a hard material selected from ruby, sapphire, diamond, ceramics, or a hard metal.

19. The nozzle arrangement according to claim 1, wherein the nozzle body (2) comprises at the bulging side of the carrier (3) a circumferential planar area (4), which in the operational position contacts a flange area of the allocated nozzle fitting.

20. The nozzle arrangement according to claim 19, wherein a seal (16) is arranged between the flange area of the nozzle holder and the circumferential planar area of the nozzle body (4).

21. The nozzle arrangement according to claim 20, wherein a circumferential groove-shaped recess (15) is provided at the circumferential planar area (4) of the nozzle body (2), that receives at least a part of a cross-section of the seal (16).

22. The nozzle arrangement according to claim 1, wherein the nozzle arrangement is adapted to be arranged at the nozzle fitting and fixed by a fixing element in a torque-proof fashion in an operational position.

23. The nozzle arrangement according to claim 1, wherein in an operational position the nozzle body (2) projects into an inlet side of the nozzle fitting so far in a direction of a cross-sectional area of a cleaning or conditioning device that inlet openings of the nozzle elements (8) are adapted to be contacted by a cleaning element arranged in the spray tube.
